(19) United States
(12) Patent Application Publication
(10) Pub. No.: US 2008/0245795 A1
(43) Pub. Date: Oct. 9, 2008

(54) Auto open closure

(76) Inventor: Gary L. Berge, Crystal Lake, IL (US)

Correspondence Address: TAFT, STETTINIUS & HOLLISTER LLP, SUITE 1800, 425 WALNUT STREET, CINCINNATI, OH, 45202-3957, US

(21) Appl. No.: 12/080,923

(22) Filed: Apr. 7, 2008

Related U.S. Application Data
(60) Provisional application No. 60/922,014, filed on Apr. 5, 2007.

(51) Int. Cl. B65D 43/26; B65D 41/16; B23P 19/04

(52) U.S. Cl. 220/264; 220/780; 29/700

(57) ABSTRACT

A closure device for a container and methods for making closure devices for containers, the closure device having a repositionable closure lid pivotably mounted to a closure body. A repositionable actuator may be incorporated into the closure body for repositioning the closure lid with respect to the closure body. The closure body may include a spout having an opening that may be closed by the closure lid.

### CROSS REFERENCE TO RELATED APPLICATION

This application claims the benefit of U.S. Provisional Application No. 60/922,014, filed Apr. 5, 2007, which is hereby incorporated by reference in its entirety.

### BACKGROUND OF THE INVENTION

1. Field of the Invention

The present invention is directed to closures and associated methods of fabricating closures and, more specifically, to closures having actuators to open and/or close lids of the closure, as well as methods of fabricating closures with actuators.

2. Description of the Related Art

Conventional containers for various products often include a cap for sealing the opening of the container. In some applications, the cap may include a hinge, thus allowing the container to be opened and closed while leaving the cap connected to the container.

### INTRODUCTION TO THE INVENTION

Embodiments of the invention provide a closure device for a container and methods for making closure devices for containers, the closure device having a repositionable closure lid pivotably mounted to a closure body. A repositionable actuator may be incorporated into the closure body for repositioning the closure lid with respect to the closure body. The closure body may include a spout having an opening that may be closed by the closure lid.

In a first aspect, a hinged closure according to the present invention may include a closure body including a spout having an outlet orifice located at a first end, an outer circumferential skirt including a first through opening, and a connecting wall extending between the spout and the outer circumferential skirt, the connecting wall having an exterior side and an interior side opposite the exterior side, and a coupling for mounting the closure body to a container; a closure lid mounted to the closure body by a hinge, the closure lid being repositionable between a closed position and an open position; an actuator movably mounted to the closure body, the actuator at least partially occupying a cavity defined by an inner surface of the outer circumferential skirt and the interior side of the connecting wall, the actuator having a first end and a second end, the first end of the actuator extending at least partially into the first through opening of the outer circumferential skirt, the actuator being radially movable between a unloaded position, in which the first end the actuator occupies at least a portion of the first through opening of the outer circumferential skirt, and a loaded position, in which the first end of the actuator has been depressed radially inwardly with respect to the outer circumferential skirt; and a spring operative to bias the actuator from the loaded position to the unloaded position; such that moving the actuator from the unloaded position to the loaded position repositions the closure lid from the closed position, if closed, to the open position; and such that the spout, the outer circumferential skirt, the connecting wall, and the coupling are formed as a unitary body.

In a detailed embodiment of the first aspect, the closure lid may includes an angled wall slidably contacting the first end of the actuator as the actuator is being moved from the unloaded position to the loaded position when the closure lid is in the closed position and the second end of the actuator may include a tab applying a force to the hinge as the actuator is being moved from the unloaded position to the loaded position when the closure lid is in the closed position, the second end of the actuator extending at least partially into a second through opening in the outer circumferential skirt proximate the hinge. The angled wall may include a surface facing generally towards the first through opening, the surface of the angled wall extending at an angle away from the connecting wall in a direction away from the spout; and movement of the actuator from the unloaded position to the loaded position may cause the first end of the actuator to slide along the surface of the angled wall, thereby exerting a force on the angled wall in a direction generally away from the connecting wall. The hinge may include a knuckle hinge. The second end of the actuator may extend through a second through opening in the outer circumferential skirt proximate the hinge and movement of the actuator from the unloaded position to the loaded position may cause the second end of the actuator to slidably contact the knuckle hinge, thereby exerting an opening force on the knuckle hinge.

In another detailed embodiment of the first aspect, the spring member may be a spring arm, the spring arm and the actuator may be formed as a unitary component, and the spring arm may be in sliding contact with a stationary surface of the closure body.

In yet another detailed embodiment of the first aspect, at least one of the actuator and the closure body may include at least one detent for mounting the actuator to the closure body in a snap-fit engagement.

In yet another detailed embodiment of the first aspect, the closure lid may include a latch, the latch may be releasably engaged with a lip located on the first end of the actuator when the closure lid is in the closed position and the actuator is in the unloaded position, and the lip may be disengaged from the latch when the actuator is in the loaded position.

In yet another detailed embodiment of the first aspect, in the closed position, a sealing portion of the closure lid may obstruct the spout at the outlet orifice and, in the open position, the sealing portion of the closure lid may not obstruct the spout.

In a second aspect, a hinged closure according to the present invention may include a closure body including a spout having an outlet orifice located at a first end, the spout having a second end opposite the first end, a coupling for mounting the closure body to a container, the coupling mounted proximate the second end of the spout, and an outer circumferential skirt substantially circumferentially surrounding the coupling and defining a generally annular cavity between an inner wall of the outer circumferential skirt and an outer wall of the coupling, the outer circumferential skirt including a first through opening and a second through opening, the second through opening being located generally opposite from the first through opening so that the coupling interposes the first through opening and the second through opening; a closure lid mounted to the closure body by a hinge, the closure lid being repositionable between a closed position and an open position; and an actuator slidably mounted to the closure body at least partially within the cavity and movable between a loaded position and an unloaded position; wherein moving the actuator from the unloaded position to the loaded position repositions the closure lid from the closed position, if closed, to the open position; wherein a first end of the actuator extends at least partially into the first through opening and a second end of the actuator extends at least partially into the second through opening; and wherein the spout, the outer circumferential skirt, and the coupling are formed as a unitary body.

In a detailed embodiment of the second aspect, the hinged closure may include a spring operative to bias the actuator towards the unloaded position. The spring may be a spring arm unitarily formed with the actuator, and the spring arm may be in sliding contact with the outer wall of the coupling.

In another detailed embodiment of the second aspect, at least one of the actuator and the closure body may include at least one detent for mounting the actuator to the closure body in a snap-fit engagement.

In yet another detailed embodiment of the second aspect, the closure lid may include a latch, the latch may be releasably engaged with a lip located on the first end of the actuator when the closure lid is in the closed position and the actuator is in the unloaded position, and the lip may be disengaged from the latch when the actuator is in the loaded position.

In yet another detailed embodiment of the second aspect, the actuator may circumscribe the outer wall of the engagement portion.

In yet another detailed embodiment of the second aspect, in the closed position, the closure lid may obstruct the outlet orifice and, in the open position, the closure lid may not obstruct the outlet orifice.

In a third aspect, a method for fabricating a closure for a container may include the steps of providing a container closure comprising a closure body and a repositionable lid mounted to the closure body obstructing a spout of the closure body in a closed position and not obstructing the spout of the closure body in an open position, the closure body including a receiver end for mounting to a container; positioning the container closure into a process tool so that the receiver end of the closure body is accessible; and installing an actuator into the container closure by way of the receiver end to provide a snap-fit engagement, where at least one of the actuator and the container closure includes detents to maintain the snap-fit engagement between the actuator and the container closure, and where operation of the actuator is operative to reposition the repositionable lid to the open position.

In a detailed embodiment of the third aspect, the actuator may be movable between a loaded position and an unloaded position, moving the actuator from the unloaded position to the loaded position may be operative to reposition the repositionable lid from the closed position, if closed, to the open position, and the actuator may be biased with respect to the container closure towards the unloaded position.

In another detailed embodiment of the third aspect, the step of installing the actuator may include installing the actuator into the closure body along a substantially axial path relative to the closure body.

In yet another detailed embodiment of the third aspect, the method may include the step of, after the step of providing the container closure, manipulating the repositionable lid into the closed position.

In yet another detailed embodiment of the third aspect, the method may include the step of, after the step of installing the actuator into the container closure, installing the receiver end of the closure body onto a container while maintaining the repositionable lid in the closed position.

In yet another detailed embodiment of the third aspect, the process tool may a high speed assembly machine.

In a fourth aspect, a method of assembling a closure for a container may include the steps of providing a closure including a closure body mounted to a closure lid by a hinge, the closure body including a receiving end for coupling to a container, a first through opening in the closure body, a second through opening in the closure body located proximate the hinge and arranged laterally opposite from the first opening, and a spout for dispensing contents of the container through the closure body; positioning the closure into a process tool so that the receiving end of the closure body is accessible; providing an actuator, the actuator including a button end sized to fit within the first through opening in the closure body and a tab end sized to fit within the second through opening in the closure body; and installing the actuator into the closure body via the receiving end so that the button end extends at least partially into the first through opening and the tab end extends at least partially into the second through opening.

In a detailed embodiment of the fourth aspect, the step of providing the closure may include the steps of molding the closure body with the closure lid in an open position and placing the closure lid in a closed position relative to the closure body.

In another detailed embodiment of the fourth aspect, the method may include the step of installing the receiving end of the closure body onto a container.

In yet another detailed embodiment of the fourth aspect, the actuator may include at least one spring unitarily formed with the actuator, the spring being operative to bias the actuator towards the button end.

### BRIEF DESCRIPTION OF THE SEVERAL VIEWS OF THE DRAWINGS

FIG. 1 is an elevated perspective view of a first exemplary closure in accordance with the instant invention, in the closed position;

FIG. 2 is an elevated perspective frontal view of the first exemplary closure of FIG. 1, in the open position;

FIG. 3 is an inverted perspective view of the first exemplary closure of FIG. 1, in the closed position;

FIG. 4 is a perspective, exploded view of the first exemplary closure of FIG. 1, in the closed position in an inverted orientation;

FIG. 5A is a cross-sectional view of the first exemplary closure of FIG. 1, in the closed position;

FIG. 5B is a cross-sectional view of the first exemplary closure of FIG. 1, partially opened;

FIG. 5C is a cross-sectional view of the first exemplary closure of FIG. 1, partially opened farther than depicted in FIG. 5B;

FIG. 6 is an elevated perspective view of a second exemplary closure in accordance with the instant invention, in the closed position;

FIG. 7 is a cross-sectional view of the second exemplary closure of FIG. 6, in the closed position;

FIG. 8 is an exploded elevation view of the second exemplary closure of FIG. 6, in the closed position;

FIG. 9 is an elevated perspective view of the second exemplary closure of FIG. 6, in the open position;

FIG. 10 is a side elevation view of the second exemplary closure of FIG. 6, in the open position; and

FIG. 11 is a cross-sectional view of the second exemplary closure of FIG. 6, in the open position.

### DETAILED DESCRIPTION OF THE INVENTION

The exemplary embodiments of the present invention are described and illustrated below to encompass container closures, as well as methods of fabricating container closures. Of course, it will be apparent to those of ordinary skill in the art that the embodiments discussed below are exemplary in nature and may be reconfigured without departing from the scope and spirit of the present invention. However, for clarity and precision, the exemplary embodiments as discussed below may include optional steps, methods, and features that one of ordinary skill should recognize as not being a requisite to fall within the scope of the present invention.

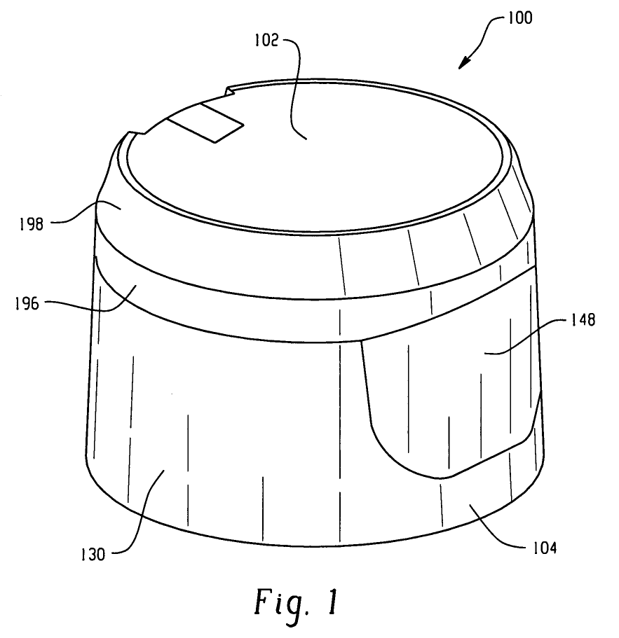

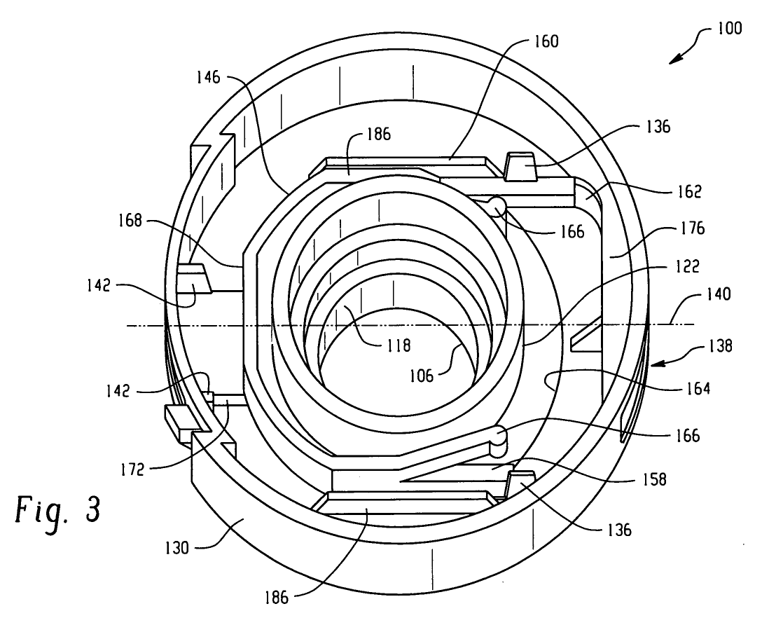

Referencing FIGS. 1-5C (and referring specifically to FIG. 3), a first exemplary closure 100 includes a lid 102 repositionably mounted to a cap 104 in order to selectively open or close off an orifice 106 extending through a spout 108. The spout 108 is integrally formed with the cap 104 and includes a conical segment 110 extending from a proximal wall 112. A proximal end of the conical segment 110 transitions into a cylindrical segment 114, having a beveled edge 116 circumscribing the orifice 106.

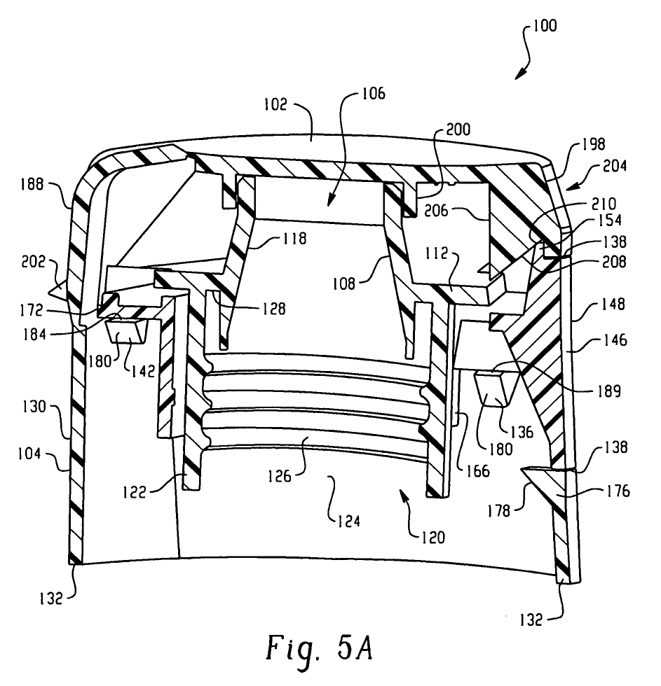

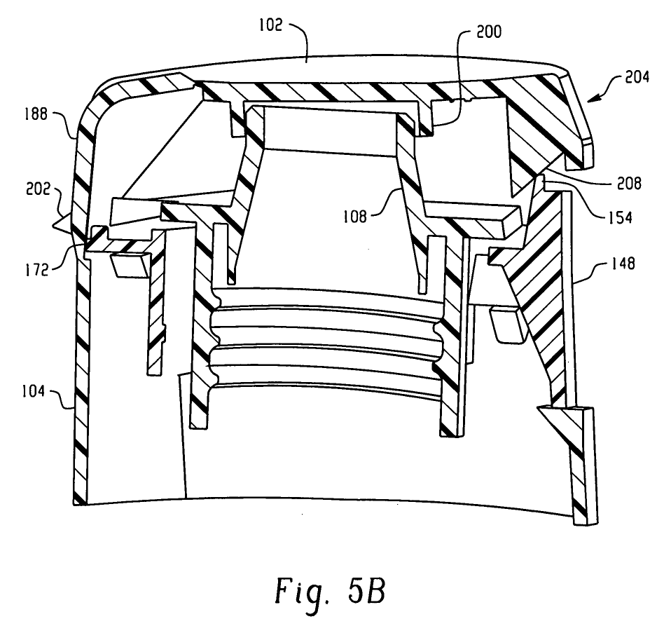

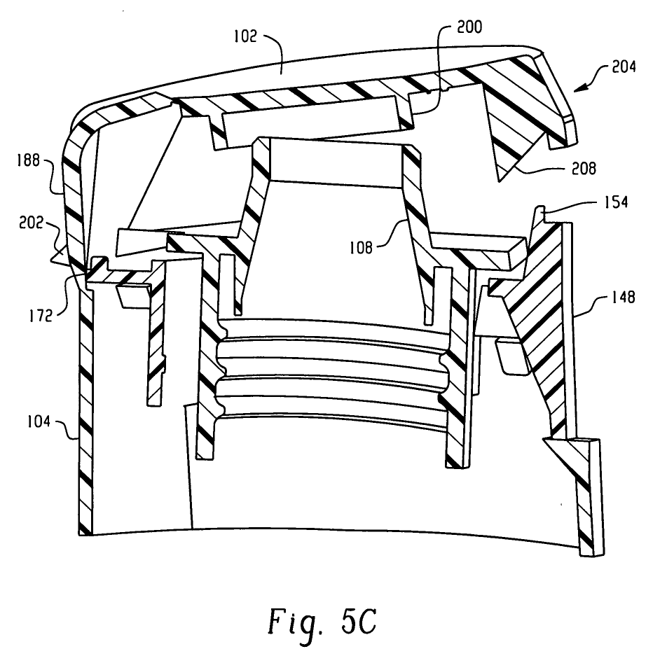

Referring to FIG. 5A, an interior surface 118 of the spout 108 extends from the orifice 106, distally beyond the proximal wall 112, and into a receiver cavity 120. The receiver cavity 120 is delineated in part by a cylindrical wall 122 extending distally from the proximal wall 112, coaxial with the spout 108, where an interior surface 124 of the cylindrical wall 122 includes helical/threaded projections 126 that are adapted to be mate with a threaded neck of a container (not shown). A circumferential rim of the container is adapted to be received between the cylindrical wall 122 and the spout 108 so that the rim of the container abuts an underneath surface 128 of the proximal wall 112. Those skilled in the art are familiar with containers having threaded necks, thus this aspect has been summarily discussed for purposes of brevity.

A circumferential skirt 130 surrounds a lower portion of the spout 108 and intersects the proximal wall 112. The skirt 130 is slightly conical, with a distal rim 132 having a greater circumference than a proximal end 134, which intersects the proximal wall 112.

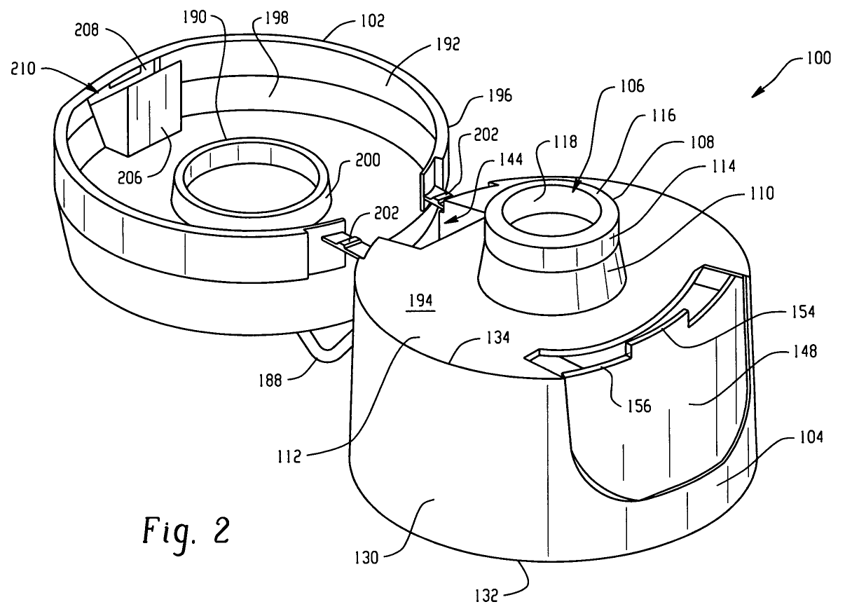

Referring to FIG. 3, a first pair of detents 136 extend from the skirt 130 near a first opening 138. The detents 136 are substantially equidistant from a diametrical midline 140 of the cap 104. A second pair of detents 142 extend from the skirt 130 approximate a second opening 144 (see FIG. 2) substantially equidistant from the diametrical midline 140 of the cap 104. These two openings 138, 144 through the skirt 130 accommodate a repositionable actuator 146, which is retained in the cap 104 using the first and second pairs of detents 136, 142.

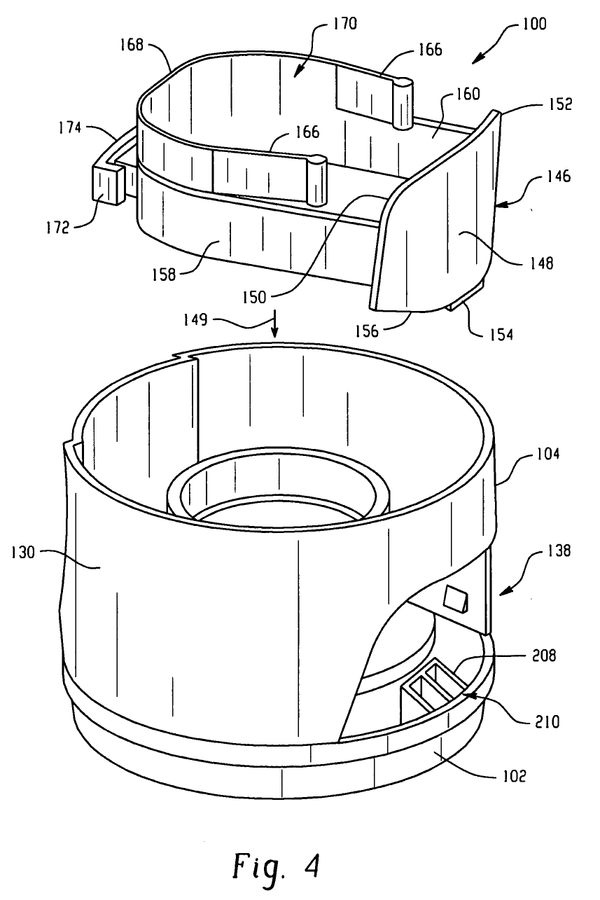

Referring to FIGS. 3 and 4, the repositionable actuator 146 includes an actuator button 148 that substantially occupies the first opening 138 through the skirt 130. The button 148 is arcuately shaped to match the arcuate circumferential contours of the skirt 130 and includes rounded left and right edges 150, 152 generally opposite an upper lip 154 that extends from a top edge 156. The upper lip 154 is adapted to engage a recess 210 in the lid 102 to retain the lid in the closed position.

Two lateral guides 158, 160 extend from a rear face 162 of the button 148 in a substantially parallel orientation with respect to one another. The space between the guides 158, 160 is selected to be slightly larger than the outer diameter of the cylindrical wall 122. An arcuate bridge 164 protrudes from the rear face 162 of the button 148 and extends between the guides 158, 160, where the arcuate shape of the bridge 164 approximates the arcuate shape of the exterior of the cylindrical wall 122. Each guide 158, 160 includes an inwardly biased spring arm 166. Opposite the button 148, the guides 158, 160 are rounded and converge to form a backstop 168. In this manner, the guides 158, 160, backstop 168, and arcuate bridge 164 cooperate to define an enclosed through hole 170 adapted to be at least partially occupied by the cylindrical wall 122, where each of the spring arms 166 is adapted to be biased against the cylindrical wall 122, on the button side of the cylindrical wall (See FIG. 3). A tab 172 having an arcuate end 174 extends outwardly from the backstop 168, opposite the button 148, and occupies a portion of the second opening 144. In this exemplary embodiment, the length of the actuator 146 between the front of the button 148 and the rear of the tab 172 is slightly less than the diameter of the skirt 130.

As show in FIG. 4, the repositionable actuator 146 is mounted to the cap 104 by aligning the actuator 146 with the cap 104 and inserting the actuator 146 from the underside of the cap 104 into a snap fit engagement with the first and second pairs of detents 136, 142. Prior to insertion, the button 148 is generally vertically aligned with the first opening 138, while the tab 172 is generally vertically aligned with the second opening 144. Also, the enclosed opening 170 is generally oriented to receive the cylindrical wall 122 of the cap 104. After proper alignment is achieved, the actuator 146 is inserted into the cap 104.

During insertion, the actuator 146 contacts and passes beyond several internal features that operate to retain the actuator in a snap-fit engagement with the cap 104. A first of these features is a forward ledge 176 that partially defines the bottom of the first opening 138. The forward ledge 176 includes an angled face 178 (see FIG. 5A) that contacts the upper lip 154 and the top edge 156 of the button 148 as the actuator 146 is inserted. Continued insertion of the button 148 against the angled face 178 of the ledge 176 causes the actuator 146 to deform slightly, with the overall length of the actuator decreasing slightly, while the overall width increases slightly, thereby enabling the actuator to pass between the ledge 176 and the opposite wall of the skirt 130. After approximately half of the button 148 has passed beyond the angled face 178 of the ledge 176, the guides 158, 160 and tab 172 contact the first and second pairs of detents 136, 144. Each detent 136, 142 includes an angled surface 180 that makes initial contact with the guides 158, 160 and tab 172 and causes the guides 158, 160 and tab 172 to deform slightly in order allow the actuator to pass beyond the detent 136, 142. Each detent 136, 142 also includes a horizontal surface 184 that captures the guides 158, 160 and tab 172 to retain the actuator 146 in a snap-fit engagement with the cap 104 after the guides 158, 160 and tab 172 pass beyond the angled surfaces 180. Once the actuator 146 has been snap-fit into the cap 104, the button 148 occupies substantially the entire first opening 138, while the tab 172 occupies a portion of the second opening 144. After the actuator 146 is mounted to the cap 104, the actuator 146 is operative to be repositioned to facilitate opening of lid 102.

The actuator 146 is repositionable with respect to the cap 104 from an unloaded position to a loaded position. When the actuator 146 is in its unloaded position, the button 148 is positioned within the first opening 138 substantially flush with the skirt 130. To reposition the actuator from the unloaded position to the loaded position, the button 148 is manually depressed in a radial direction to drive the entire actuator 146 in parallel with the midline 140 and substantially linearly with respect to the cap 104. The actuator 146 rides upon the horizontal surfaces 184 of the first and second pairs of detents 136, 142 and is retained in a substantially linear path by a pair of alignment fins 186 (see FIG. 3) that extend from the proximal wall 112 on lateral opposing sides of the spout 108. As the button 148 is depressed toward the spout 108, the spring arms 166 of each guide 158, 160 are forced outward by contact with the spout 108, against the inward bias the spring arms. At the same time, the tab 172 is being moved toward a knuckle hinge 188 of the lid 102. When the tab 172 is substantially flush with the skirt 130 and the button 148 is recessed within the first opening 138, the actuator 146 is in its loaded position (As will be described in detail below, depressing the button 148 in this manner also repositions the lid 102 from a closed position, if closed, to an open position). The bias of the spring arms 166 is operative to drive the actuator 146 back to its unloaded position, presuming no opposing force is applied to the actuator, such as when a user's finger is no longer depressing the button 148. This movement of the actuator 146 back to the unloaded position occurs whether or not the lid 102 is moved to its closed position.

Referencing FIG. 3, the lid 102 comprises a substantially circular top wall 190 and a brim 192 extending from the top wall that is adapted to sit upon a top surface 194 of the proximal wall 112 when the lid is in the closed position. The brim 192 includes a generally cylindrical portion 196 that tapers into a generally conical portion 198 that intersects the top wall 190. A circular ring 200 extends from the top wall 190 on the interior of the lid 102 and is adapted to circumscribe the top of the spout 108 to close off the orifice 106 when the lid 102 is in the closed position. A rear portion of the brim 192 includes a pair of modified butterfly living hinges 202 that connect the lid 102 to the skirt 130 of the cap 104. A third living hinge 188 comprises a knuckle hinge consisting of a cut-out from the brim 192, conical portion 189, and top surface 194. The knuckle hinge 188 is operative to provide a spring force to retain the lid 102 in the open position after a predetermined initial opening force has been applied to the lid.

Referring to FIG. 5A, a complementary latch 204 protrudes from the top wall 190 and conical portion 198 on the interior of the lid 102, which is adapted to engage the lip 154 of the button 148 when the lid 102 is in the closed position. The latch 204 includes a generally vertical wall 206 intersected by an angled wall 208 extending toward the brim 192 to form a recess 210 adjacent the brim. This recess 210 receives the lip 154 of the button 148 when the lid 102 is in the closed position. As will be discussed in more detail below, repositioning the button 148 toward the spout 108 (manually depressing the button) is operative to cause the lip 154 to contact the angled wall 208 and open the lid 102.

Repositioning the lid 102 from the closed position (see FIG. 1) to the open position (see FIG. 2) involves repositioning the actuator 146 by manually depressing the button 148. When the lid 102 is in the closed position, the circular ring 200 circumscribes the top of the spout 108 to close off the orifice 106 and the lip 154 of the button 148 lies within the recess 210 of the lid 102. To open the lid 102, a user may push the button 148 toward the spout 108 and into the interior of the cap 104. By moving the button 148 toward the spout 108, the lip 154 contacts the angled wall 208 of the latch 204, thereby pushing the lid 102 upward. At the same time as the lip 154 is contacting the angled wall 208 of the latch 204, the tab 172 is contacting the knuckle hinge 188. The movement of the lip 154 against the angled wall 208 is operative to disengage the circular ring 200 from the spout 108. Once this disengagement occurs, the pair of modified butterfly living hinges 202 retains the lid 102 in a slightly open position (see FIG. 5B). The lip 154 then passes beyond the angled wall 208 and the tab 172 contacts the knuckle hinge 188 (see FIG. 5C). Force applied by the tab 172 overcomes the bias of the butterfly living hinges 202, thereby using the spring force of the knuckle hinge 188 to rotate the lid 102 to the fully open position (approximately 100 degrees of travel) (see FIG. 2). After the tab 172 has repositioned the lid 102 to its open position, the user may release the button 148. When the user releases the button, the spring arms 166 of each guide 158, 160 force the button 148 back to its original position substantially flush with the skirt 130. In this manner, the button 148 is self-loading.

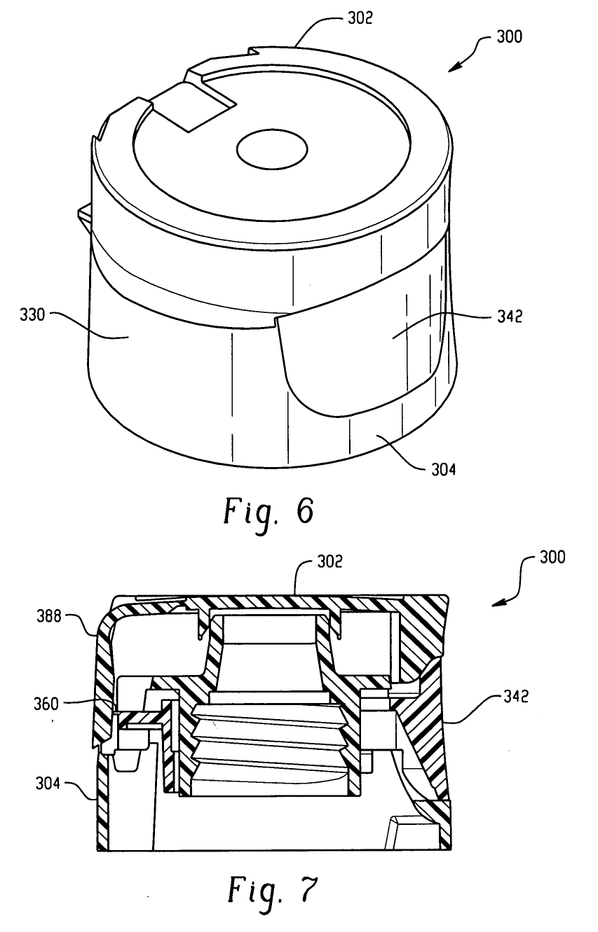

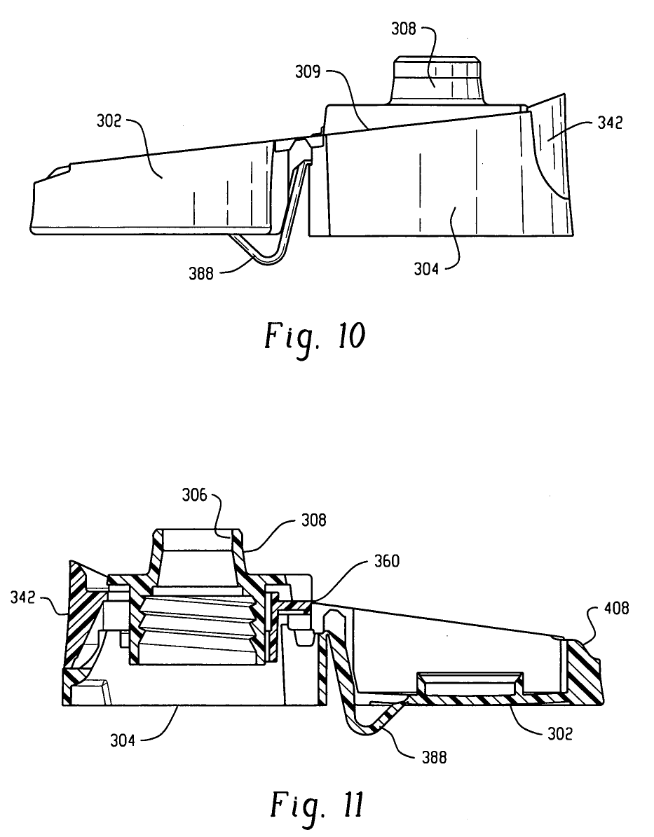

Referring to FIGS. 6-11, a second exemplary closure 300 includes a lid 302 repositionably mounted to a cap 304 in order to selectively open or close off an orifice 306 extending through a spout 308.

The second exemplary closure 300 is very similar to the first exemplary closure 100, but does differ in one primary respect: the second exemplary closure 300 does not utilize its actuator 342 to retain the lid 302 in the closed position. Instead, the closure 300 includes a circumferential groove 309 (see FIG. 9) formed at the top of the skirt 330 that receives an edge of the lid 302 to retain the lid 302 in the closed position. Similarly to the first exemplary closure, contact between the actuator 342 and the angled wall 408 forces the lid from the circumferential groove 309 initially, and thereafter the tab 360 contacts the knuckle hinge 388 to fully open the lid 302. The actuator 342 is substantially similar to the first exemplary actuator and works in the same manner, with the exception of the omission of the upper lip 154. Closure 300 is assembled in substantially the same manner as closure 100.

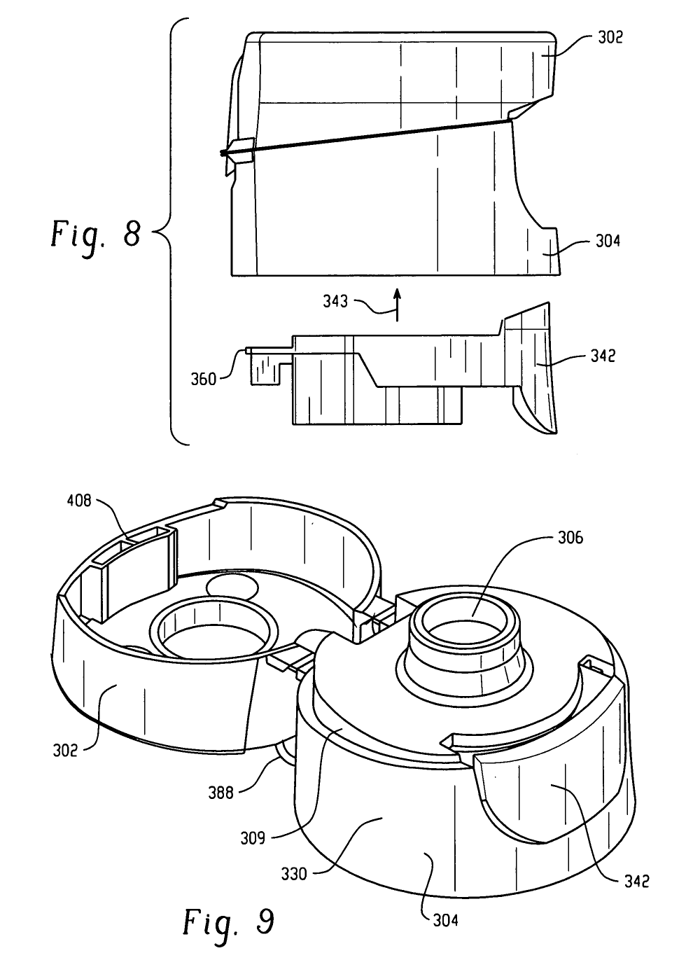

Each of the foregoing exemplary embodiments is designed for high speed automated assembly. In particular, each of the embodiments is amendable to assembly by high speed machinery that take the closures 100, 300 in the closed position (i.e., where the lid closes off the orifice of the spout) and inserts the repositionable actuators 146, 342 from underneath the closure. Arrow 149 and arrow 343 indicate the direction of insertion of the repositionable actuators 146, 342 in FIGS. 4 and 8, respectively. In other words, the same end of the closure 100, 300 that will receive the threaded neck of a container receives the actuator prior to receiving the threaded neck of the container. Because of the design of the closures 100, 300, the actuators 146, 342 are amendable to simple vertical insertion. This means that the high speed equipment need only to reposition the actuators 146, 342 along a single axis, without having to perform multiple repositioning steps along multiple axes. Those skilled in the art will readily understand the advantages of high speed processing and why allowing the insertion of the actuator 146, 342 while the lid is closed is advantageous and novel over the prior art. Exemplary reasons for inserting the actuator 146 into the closure in the closed position include, without limitation, lower manufacturing costs as well as ease of manufacturing.

While the foregoing embodiments have been described as including butterfly hinges, it is to be understood that other hinges may be utilized, such as simple living hinges or other appropriate hinges known in the art or later developed.

Following from the above description and invention summaries, it should be apparent to those of ordinary skill in the art that, while the methods and apparatuses herein described constitute exemplary embodiments of the present invention, the invention contained herein is not limited to these precise embodiments and that changes may be made to the exemplary embodiments without departing from the scope of the invention as defined by the claims. Additionally, it is to be understood that the invention is defined by the claims and it is not intended that any limitations or elements included in the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A hinged closure comprising:
a closure body including
a spout having an outlet orifice located at a first end,
an outer circumferential skirt including a first through opening, and
a connecting wall extending between the spout and the outer circumferential skirt, the connecting wall having an exterior side and an interior side opposite the exterior side, and
a coupling for mounting the closure body to a container;
a closure lid mounted to the closure body by a hinge, the closure lid being repositionable between a closed position and an open position;
an actuator movably mounted to the closure body, the actuator at least partially occupying a cavity defined by an inner surface of the outer circumferential skirt and the interior side of the connecting wall, the actuator having a first end and a second end, the first end of the actuator extending at least partially into the first through opening of the outer circumferential skirt, the actuator being radially movable between a unloaded position, in which the first end the actuator occupies at least a portion of the first through opening of the outer circumferential skirt, and a loaded position, in which the first end of the actuator has been depressed radially inwardly with respect to the outer circumferential skirt; and
a spring operative to bias the actuator from the loaded position to the unloaded position;
wherein moving the actuator from the unloaded position to the loaded position repositions the closure lid from the closed position, if closed, to the open position; and
wherein the spout, the outer circumferential skirt, the connecting wall, and the coupling are formed as a unitary body.

2. The hinged closure of claim 1, wherein the closure lid includes an angled wall slidably contacting the first end of the actuator as the actuator is being moved from the unloaded position to the loaded position when the closure lid is in the closed position; and
wherein the second end of the actuator includes a tab applying a force to the hinge as the actuator is being moved from the unloaded position to the loaded position when the closure lid is in the closed position, the second end of the actuator extending at least partially into a second through opening in the outer circumferential skirt proximate the hinge.

3. The hinged closure of claim 2, wherein the angled wall includes a surface facing generally towards the first through opening, the surface of the angled wall extending at an angle away from the connecting wall in a direction away from the spout; and
wherein movement of the actuator from the unloaded position to the loaded position causes the first end of the actuator to slide along the surface of the angled wall, thereby exerting a force on the angled wall in a direction generally away from the connecting wall.

4. The hinged closure of claim 2, wherein the hinge comprises a knuckle hinge;
wherein the second end of the actuator extends through a second through opening in the outer circumferential skirt proximate the hinge; and
wherein movement of the actuator from the unloaded position to the loaded position causes the second end of the actuator to slidably contact the knuckle hinge, thereby exerting an opening force on the knuckle hinge.

5. The hinged closure of claim 1, wherein the spring member is a spring arm, the spring arm and the actuator are formed as a unitary component, and the spring arm is in sliding contact with a stationary surface of the closure body.

6. The hinged closure of claim 1, wherein at least one of the actuator and the closure body includes at least one detent for mounting the actuator to the closure body in a snap-fit engagement.

7. The hinged closure of claim 1, wherein the closure lid includes a latch, the latch is releasably engaged with a lip located on the first end of the actuator when the closure lid is in the closed position and the actuator is in the unloaded position, and the lip is disengaged from the latch when the actuator is in the loaded position.

8. The hinged closure of claim 1, wherein, in the closed position, a sealing portion of the closure lid obstructs the spout at the outlet orifice and, in the open position, the sealing portion of the closure lid does not obstruct the spout.

9. A hinged closure comprising:
a closure body including
a spout having an outlet orifice located at a first end, the spout having a second end opposite the first end,
a coupling for mounting the closure body to a container, the coupling mounted proximate the second end of the spout, and
an outer circumferential skirt substantially circumferentially surrounding the coupling and defining a generally annular cavity between an inner wall of the outer circumferential skirt and an outer wall of the coupling, the outer circumferential skirt including a first through opening and a second through opening, the second through opening being located generally opposite from the first through opening so that the coupling interposes the first through opening and the second through opening;
a closure lid mounted to the closure body by a hinge, the closure lid being repositionable between a closed position and an open position; and
an actuator slidably mounted to the closure body at least partially within the cavity and movable between a loaded position and an unloaded position;
wherein moving the actuator from the unloaded position to the loaded position repositions the closure lid from the closed position, if closed, to the open position;
wherein a first end of the actuator extends at least partially into the first through opening and a second end of the actuator extends at least partially into the second through opening; and
wherein the spout, the outer circumferential skirt, and the coupling are formed as a unitary body.

10. The hinged closure of claim 9, further comprising a spring operative to bias the actuator towards the unloaded position.

11. The hinged closure of claim 10, wherein the spring is a spring arm unitarily formed with the actuator, and
wherein the spring arm is in sliding contact with the outer wall of the coupling.

12. The hinged closure of claim 9, wherein at least one of the actuator and the closure body includes at least one detent for mounting the actuator to the closure body in a snap-fit engagement.

13. The hinged closure of claim 9, wherein the closure lid includes a latch, the latch is releasably engaged with a lip located on the first end of the actuator when the closure lid is in the closed position and the actuator is in the unloaded position, and the lip is disengaged from the latch when the actuator is in the loaded position.

14. The hinged closure of claim 9, wherein the actuator circumscribes the outer wall of the engagement portion.

15. The hinged closure of claim 9, wherein, in the closed position, the closure lid obstructs the outlet orifice and, in the open position, the closure lid does not obstruct the outlet orifice.

16. A method for fabricating a closure for a container comprising the steps of:
providing a container closure comprising a closure body and a repositionable lid mounted to the closure body obstructing a spout of the closure body in a closed position and not obstructing the spout of the closure body in an open position, the closure body including a receiver end for mounting to a container;
positioning the container closure into a process tool so that the receiver end of the closure body is accessible; and
installing an actuator into the container closure by way of the receiver end to provide a snap-fit engagement, where at least one of the actuator and the container closure includes detents to maintain the snap-fit engagement between the actuator and the container closure, and where operation of the actuator is operative to reposition the repositionable lid to the open position.

17. The method of claim 16, wherein the actuator is movable between a loaded position and an unloaded position, moving the actuator from the unloaded position to the loaded position is operative to reposition the repositionable lid from the closed position, if closed, to the open position, and the actuator is biased with respect to the container closure towards the unloaded position.

18. The method of claim 16, wherein the step of installing the actuator includes installing the actuator into the closure body along a substantially axial path relative to the closure body.

19. The method of claim 16, further comprising the step of, after the step of providing the container closure, manipulating the repositionable lid into the closed position.

20. The method of claim 16, further comprising the step of, after the step of installing the actuator into the container closure, installing the receiver end of the closure body onto a container while maintaining the repositionable lid in the closed position.

21. The method of claim 16, wherein the process tool is a high speed assembly machine.

22. A method of assembling a closure for a container comprising the steps of:
providing a closure including a closure body mounted to a closure lid by a hinge, the closure body including
a receiving end for coupling to a container,
a first through opening in the closure body,
a second through opening in the closure body located proximate the hinge and arranged laterally opposite from the first opening, and
a spout for dispensing contents of the container through the closure body;
positioning the closure into a process tool so that the receiving end of the closure body is accessible;
providing an actuator, the actuator including a button end sized to fit within the first through opening in the closure body and a tab end sized to fit within the second through opening in the closure body; and
installing the actuator into the closure body via the receiving end so that the button end extends at least partially into the first through opening and the tab end extends at least partially into the second through opening.

23. The method of claim 22, wherein the step of providing the closure includes the steps of:
molding the closure body with the closure lid in an open position; and
placing the closure lid in a closed position relative to the closure body.

24. The method of claim 22, further comprising the step of installing the receiving end of the closure body onto a container.

25. The method of claim 22, wherein the actuator includes at least one spring unitarily formed with the actuator, the spring being operative to bias the actuator towards the button end.
